(19) United States
(12) Patent Application Publication
(10) Pub. No.: US 2003/0183705 A1
(43) Pub. Date: Oct. 2, 2003

(54) Method and device for the dry separation of unsorted garbage that contains packaging waste

(76) Inventors: Joachim Christiani, Essen (DE); Ralf Hofer, Essen (DE)

Correspondence Address: Aslan Baghdadi, Shaw Pittman, 1650 Tysons Boulevard, McLean, VA, 22102, US

(21) Appl. No.: 10/275,551

(22) PCT Filed: May 9, 2001
(86) PCT No.: PCT/DE01/01799

(30) Foreign Application Priority Data
May 17, 2000 (DE) 100 24 309.6

(51) Int. Cl. B02C 11/08; B02C 21/00

(52) U.S. Cl. 241/23

(57) ABSTRACT

The invention relates to a method for the dry separation of unsorted garbage that contains packaging waste consisting of plastic materials of various polymer groupings that includes the following steps: separation of the materials on the basis of differences in size; separation of the materials on the basis of differences in grain shape, grain size and/or specific weight; separation of the materials on the basis of differences in their magnetic properties; separation of the materials on the basis of differences in their electric properties; and separation of the materials on the basis of differences in their spectroscopic properties. Every separation step is carried out at least once and the separation of components of the unsorted garbage results in a remaining material throughput that contains non-recyclable residual waste and plastic articles from which the plastic articles are collectively removed in the form of a mixed plastic fraction and said mixed plastic fraction is selectively separated into essentially polymer-specific fractions using polymer-specific separation methods. The invention also relates to a device for the implementation of the inventive method.

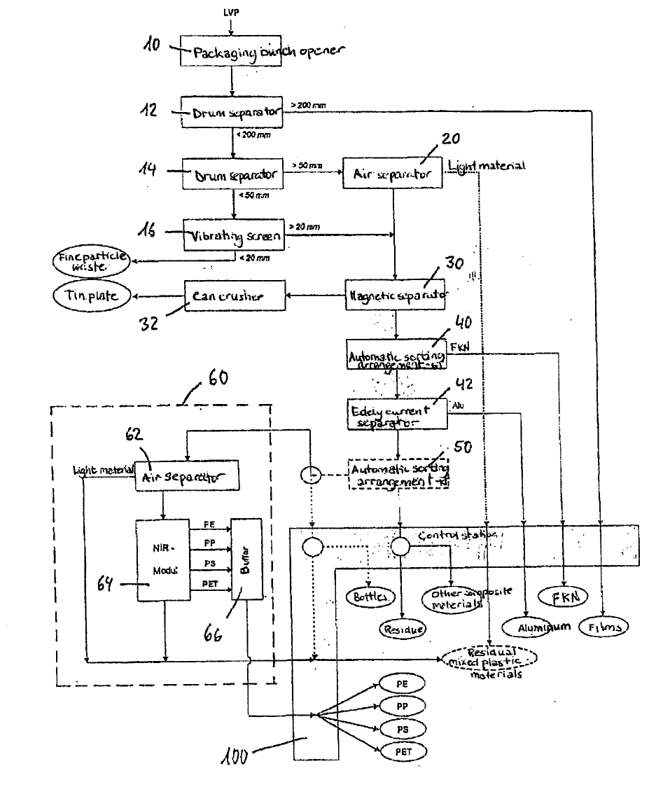

The invention relates to a method for the dry separation of unsorted garbage that contains packaging waste consisting of plastic materials of various polymer groupings whereby a material flow is freed step-by-step from interfering materials in the following steps: separation of the materials on the basis of differences in size; separation of the materials on the basis of differences in grain shape, grain size and/or specific weight; separation of the materials on the basis of differences in their magnetic properties; separation of the materials on the basis of differences in their electric properties; and separation of the materials on the basis of differences in their spectroscopic properties whereby every separation step is performed at least once. The invention also relates to a device for the implementation of the inventive method.

The context of the implementation of the present invention packaging waste includes consumer packaging that contains plastic components, plastic containers, plastic cups and bowls with reasonably stable shapes, films, sheet metal and tin containers, packaging containing aluminum and liquid and beverage cartons either with or without aluminum content. This packaging waste is household garbage that is contaminated or has also been mixed with residual waste. Residual waste components such as pieces of glass and ceramic, plants, food, diapers and so forth cannot be recycled by the method disclosed in the present invention. Those components either can be separately recycled as is common for glass and paper or will not contain any recyclable components at all such as is the case with plants and food remainders.

Sorting of plastic consumer packaging collected from households is essentially manual or partly mechanical and the entire flow of material destined for sorting and recycling is sorted into the “plastic films”, “plastic bottles” and “mixed plastic materials” categories. In this case, the mixed plastic materials category will constitute the largest and most significant segment of the fraction. Today, such material is usually recycled using so-called raw material methods even though it contains significant amounts of potentially recyclable components that are not fully being taken advantage of even when the separation method used facilitates a relatively complete sorting process using polymer structure as the criteria. WO99/26734, for example, relates to a method and a device for the identification and sorting of objects being led along on a belt conveyer whereby the material structures of the objects are determined using NIR spectroscopy.

In accordance with the invention, “mixed plastic materials” or “mixed plastic fraction” means a fraction that has essentially been freed of large plastic film remainders but which could still contain smaller film residues and bottles. This definition takes into account that the composition of the types of plastic materials has changed in the past few years rendering the previously valid specifications used by the Duales System in this connection unreliable. For example, a production related visual characteristic such as “bottle” rarely corresponds to previously defined types of plastic such as “HDPE” (High Density Polyethylene). Therefore, the ports for plastic recycling or, as the case may be, for plastic recovery are less and less suitable for the production specifications.

Sorting equipment used by the company Trienekens which is described in the symposium “Identiplast” (26, 28.04.1999, Brussels) and is titled “High Volume Plastics Identification and Sorting—Practical Experiences”, comprises a method that, firstly, separates packaging waste in a drum separator and frees the part of the packaging waste that has a size of less than 320 mm from ferromagnetic components using an overhead magnet and then frees it from those fraction parts that are smaller than 120 mm in another drum separator whereby the screen drain is subsequently led to an air separator. The heavy material fraction from the air separator is separated in a cascade of consecutive automatic sorting devices that removes polymer-specific plastic objects from the material flow using NIR. Correspondingly, at the end of the separation cascade for the polymer-specific plastic materials, paper and cardboard as well as aluminum are separated. Subsequently, ferrous material is segregated using a magnetic drum. This method facilitates the selective separation of individual components from the entire material flow according to material structure and/or separation behavior in the screens or air separators by including various additional manual separation stations and re-circulation processes of individual component flows.

On the Internet site of Anwender- und Innovationsforum Umwelttechnologie AIFU Wirtschaftsraum Heilbronn [The User and Innovation Forum Environment Technology AIFU, Heilbronn region] (http://www.aifu.de), a semi-automatic sorting method of materials from the collection bag that contains potentially recyclable materials is described. Firstly, a light material fraction is prepared using air separation that is then classified into a coarse fraction and a fine fraction in a drum separator maintaining the separation size at approximately 180 mm. The coarse fraction will contain the plastic films. The fine fraction undergoes magnetic segregation. Finally, the non-ferrous metals are sorted out using, for example, an eddy current separator. The resulting potentially recyclable fraction is then freed from beverage cartons that contain aluminum using automatic sorting. In a subsequent drum separation step the fine particle content is removed from the waste. The remaining waste flow is led to a semi-automatic sorting line where a robot separates the potentially recyclable materials including plastic materials whereby individual potentially recyclable materials are assigned using manual separation and the robot is notified via a touch display. Additionally, a completely manual selection is performed.

In “Kreislaufwirtschaft nach dem Muster der Verpackungsverordnung: Untersuchungen zu Umsetzung und Perspektiven unter besonderer Berücksichtung aufbereitungstechnischer und abfallwirtschaftlicher Gesichtspunkte” [Life-cycle Management in Accordance with the Guidelines of the Packaging Ordinance: Analysis of the Implementation and Opinions with particular regard to Recycling and Waste Management], Joachim Christiani, Shaker Publishing 1997, pp. 52,53, the Thyssen-Henschel method is described. Essentially, this method is a mechanical separation process for packaging materials. Firstly, the material flow is separated in the drum separator that is fitted with a mesh size that collects the large area films into the screen drain where they are further purified in a subsequent air separator as the large volume, shape stable components are segregated. The screened light material essentially consists of films and the screened heavy material is removed in the form of residual sorting material. Tin plate is removed from the through fraction using overhead magnets and non-ferrous metal containing components are removed using eddy current separation. The non-ferrous content is separated in a final screen classification step whereby aluminum coated packaging is collected in the screen drain and other aluminum containing packaging is collected in the through fraction. The discharge from the eddy current separator is exposed to a first automatic segregation whereby non-aluminum coated cartons for liquid are sorted out and united with the aluminum containing cartons for liquid using a pneumatic ejection. The resulting fraction containing cartons for liquid use or, as the case be, aluminum containing materials is manually checked for sorting errors before final pressing to finished product. The remaining material flow is led over a sorting platform from which, at a third sorting place, paper and cardboard as well as their composites are manually sorted out. The material flow that passes the scanning location undergoes an additional air separation that results in the formation of a light material mixed plastic fraction. After conditioning, the heavy material from the screen is led to a two-step automatic sorting process using NIR (near infrared) reflectance via a so-called roller bench, fine particle screening and acceleration belt. The products that result from these separation steps are hollow articles made from polyethylene and from other types of plastic except polyvinyl chloride. The discharge from the roller bench and the screen accumulates as remainder material together with the discharge from the automatic segregation.

WO99/34927 relates to an automatic treatment process. Here materials are removed from the waste flow at several stations in automatic sorting installations. The device described in WO99/34927 uses separation installations at three locations that use optical recognition of geometric shapes, NIR spectroscopy, light sensing or color recognition and each of which removes mixed plastic material from the material throughput sorted into polymer groupings.

Well-known separation methods are in particular designed to selectively separate individual material categories from the material throughput using subsequent separation steps. In this manner, potentially recyclable materials are separated from the material throughput according to their magnetic or electric characteristics, their flight behavior in air separators or according to their absorption behavior, for example, of near infrared radiation.

The described approaches are expensive due to the material throughput volume that must be transported and treated in each separation step.

Therefore, it is an object of the present invention to provide a process and a device for the dry separation of unsorted garbage that includes packaging waste whereby the separation of plastic material and the sorting of said plastic material into polymer groupings can be achieved with a higher yield rate than previously possible. In particular, the conversion of existing equipment to allow implementation of the new process is possible.

This object is achieved in a process according to claim 1. A device for the implementation of the process is described in claim 8.

In accordance with the present invention, the separation of components from the unsorted garbage leads to the formation of a remaining material throughput that contains non-recyclable household waste components—also denoted as residual waste—and plastic articles from which material throughput the plastic articles collectively can be segregated as a mixed plastic material fraction and the mixed plastic fraction selectively is separated in a polymer-specific separation process into essentially polymer-specific fractions.

Preferably, large surface area films are segregated in a screen or air separator prior to the segregation of the mixed plastic fraction. In this connection, the air separation permits the separation on the basis of differences in grain shape, grain size and/or specific weight. The grain shape plays the most important role for the air separation process.

The polymer-specific separation of the mixed plastic fraction can be achieved using NIR spectroscopy. It is particularly preferred that film components that may remain be removed from the collectively separated mixed plastic fraction since they would interfere during the final selective separation steps.

The essentially polymer-specific fractions resulting from the separation are preferably collected in individual buffer bins. The buffer bins could alternately be individually emptied and the content could be led to an additional control step verifying the polymer-specific composition. This additional control step could consist of a manual re-sorting process.

The device for the dry separation of unsorted garbage containing packaging waste generates a mixture that includes non-recyclable residual waste and a mixed plastic fraction through the use of screens, air separators, magnetic separators, eddy current separators and installations for the separation of materials on the basis of their spectroscopic properties whereby a sorting installation is located further downstream that collectively extracts the mixed plastic fraction from the mixture and supplies it to a module where the mixed plastic fraction is sorted into polymer groupings. The module is fitted with at least one separation installation that uses near infrared spectroscopy which selectively sorts the mixed plastic fraction into essentially type-specific polymer groupings.

This separation installation could be series-connected to an air separator or a suction charged inclined conveyer belt leading the heavy fraction to the separation installation.

It is also possible that the separation installation be series-connected to a buffer intended for each polymer grouping.

Firstly, in a process that sorts out possibly present large surface area films and, in particular, that removes non-plastic materials such as, for example, ferrous and non-ferrous metals from the collective material flow, a fraction consisting of residual waste and other plastic articles such as, for example, plastic cups and bowls results. From this fraction consisting of residual waste and plastic articles a mixed plastic fraction is collectively extracted as the plastic articles are separated from the residual waste, for example, by using a simple spectroscopic method that uses, for example, NIR. At this point, the resulting mixed plastic fraction is essentially free of residual waste components and is now selectively separated into individual polymer groupings. NIR spectroscopy is particularly suitable for this selective separation which essentially generates fractions that are sorted to be as type-specific as possible, or as the case may be, to have high concentrations of particular types of plastics, for example, polyethylene, polypropylene, polystyrene, polyethylene terephthalate an so forth.

In a best mode of the invention, the highly concentrated plastic fractions are placed into intermediate storage in individual buffer bins until they are alternately individually emptied and led to an additional control step merely on a conveyer installation. The additional control step could, for example, consist of a manual re-sorting process to achieve higher levels of purity of the plastic types. It is particularly preferred that, after the automatic selective separation, just one control device, or as the case may be, one person is necessary for manual re-sorting in the follow-up control process of the highly concentrated plastic types that alternately are delivered so that each highly concentrated plastic type can be delivered to the same control location.

The method according to the invention thus describes a collective selective sorting process, in other words, after the removal of large surface films, all non-plastic materials are specifically removed from the material throughput so that plastic materials and residual waste remain which will have reduced the processing flow rate for the subsequent selective separation of individual polymer groupings by approximately 60 to 70% compared to other well known methods.

The residual waste in the remaining material throughput is collectively separated from the plastic articles and could be delivered to an additional control step, for example, a manual re-sorting process to remove any potentially remaining recyclable materials.

Additionally, this new method facilitates modular supplementation of existing equipment while methods described in prior art essentially require far reaching restructuring of existing equipment.

The device required to implement the entire separation process has at least one regular screen, for example, a rod screen from which the coarse fraction is led to an air separator. A magnetic separator takes over the heavy fraction from the air separator in which in particular tin plate is sorted out. The material flow that has now been freed from metal reaches an automatic separation device (automatic-sorting arrangement) that is suitable for the removal of beverage cartons using, for example, optical detection. The material flow continuously cleaned in this manner reaches an eddy current separator that removes non-ferrous metals. The remaining share of the material throughput now consists of residual waste such as glass and ceramic shards, diapers, coffee grounds and other household waste components such as plastic articles like, for example, plastic cups, bowls and tubes. The composition of the remaining material throughput varies but past experience confirms that the non-plastic content share of household waste is approximately 70 wt. % and the plastic article share is approximately 30 wt. %. As has been shown above, a relatively crude optical identification process such as, for example, NIR spectroscopy is used to collectively separate the plastic articles from the household waste components. The mixed plastic fraction obtained in this manner is identified and selectively separated using optical separation processes such as, for example, polymer-specific spectroscopy processes. In a preferred mode, prior to the selective separation, the mixed plastic fraction is freed from remaining residual film in an air separator so that relatively structurally stable plastic articles remain.

Below, the invention is described in greater detail in the enclosed FIGURE which is the sole FIGURE, namely a schematic flow chart of the process according to the invention.

It has been predetermined that all sorted recyclable materials flows can be sent to one single control location 100, for example, to a manual re-sorting process before being placed in intermediate storage in bins or other such storage units.

The light packaging material (LVP) that is usually delivered in sacks or in waste bales is automatically opened by a packaging bunch opener 10 and sent to a drum separator 12 fitted with an approximately 200 mm wide hole opening. The coarse fraction in the drum separator 12, in other words, materials with grain sizes larger than 200 mm, primarily consists of plastic films which are then sent to the control station 100 where they are separately treated. The fine particle fraction in the drum separator 12 enters another drum separator 14 fitted with a hole with a diameter of approximately 50 mm. The coarse fraction in the drum separator 14 is led to an air separator 20 where it undergoes gravity separation. The light material which mainly consists of pieces of film and other such material is also led to the control station 100 and collected there as “remainder mixed plastic material”. In this manner, the majority of interfering film has been removed. The invention does not deal with the sorting of such large surface film.

The fine particle material in the drum separator 14 is freed from dust in a vibrating screen 16 fitted with an approximately 20 mm diameter hole. The extracted fine waste is disposed of. The coarse fraction from the vibrating screen 16 is led into a magnetic separator 30 together with the heavy fraction from the air separator 20. Here magnetic metals are removed, mainly tin plate, which are then moved to a can crusher 32 where they will be further prepared for transport and left available as a potentially recyclable materials. The remaining material flow is sent to an automatic sorting arrangement 40 that optically detects beverage packaging and removes it via the control station 100. A fraction consisting mainly of aluminum is removed from a series-connected eddy current separator 42 that is responsible for the removal of non-ferrous metals. This fraction is also sent for interim storage via the control station 100 to await further treatment.

To separate the residual waste components in the remaining material throughput from the plastic components an optical separation installation such as, for example, a common automatic sorting arrangement 50 for plastic materials is series-connected. The collectively separated mixed plastic fraction is selectively separated into individual polymer groupings in the module 60. The remainder that was removed from the automatic sorting arrangement 50 is segregated via the control station 100 as non-recyclable material. It is possible to remove bottles from the separated mixed plastic flow as it leaves the automatic sorting arrangement 50 using, for example, shape recognition.

The module 60 could, for example, consist of an air separator 62, that can perform an additional cleaning step to remove any remaining plastic films and other flat components which are then led to the “remaining mixed plastic materials” as light material. The heavy material from the air separator 62 goes to the NIR module 64 where the spectroscopic separation into individual polymer groupings such as, for example, polyethylene (PE), polypropylene (PP), polystyrene (PS) and polyethylene terephthalate (PET) occurs. The groupings then reach a buffer 66 and are intermittently sent to the control station 100.

A suction charged inclined conveyer belt can be used instead of or in conjunction with the air separator in the module 60 to hold in place the films while they are being moved in an upwards direction.

The characteristics of the invention revealed in the above description, in the drawing, as well as in the patent claims could be significant for the realization of the invention individually as well as in any combination.

1. Method for the dry separation of unsorted garbage that contains packaging waste consisting of plastic materials of various polymer groupings, including the following steps of:
separating the materials on the basis of differences in size;
separating the materials on the basis of differences in grain shape, grain size and/or specific weight;
separating the materials on the basis of differences in their magnetic properties;
separating the materials on the basis of differences in their electric properties; and
separating the materials on the basis of differences in their spectroscopic properties,
whereby every separation step is carried out at least once, characterized by the fact that
the segregation of the unsorted waste components leads to the formation of a remaining material throughput which is a mixture that contains non-recyclable residual waste components and plastic articles from which the plastic articles are collectively separated in the form of a mixed plastic fraction, and
said mixed plastic fraction is selectively separated into essentially polymer-specific fractions using polymer-specific separation methods.

2. Method according to claim 1, characterized by the fact that large surface films are separated prior to the segregation of the mixed plastic fraction using screening and/or air separation.

3. Method according to claim 1 or 2, characterized by the fact that the plastic articles are collectively separated from the residual waste using a NIR spectroscopy process.

4. Method according to one of the above claims, characterized by the fact that the polymer-specific separation of the mixed plastic fraction occurs using NIR spectroscopy.

5. Method according to one of the above claims, characterized by the fact that film components are removed from the collectively separated mixed plastic fraction.

6. Method according to one of the above claims, characterized by the fact that the essentially polymer-specific fractions are each separately collected in individual buffer bins.

7. Method according to claim 6, characterized by the fact that the buffer bins are alternately individually emptied and led to an additional control of the polymer-specific content.

8. Method according to claim 7, characterized by the fact that the additional control is a manual re-sorting process.

9. Device for the dry separation of unsorted garbage that contains packaging waste that contains plastic materials, in particular for the implementation of the method in accordance with one of the above claims, comprising:
at least one screen (12, 14, 16) for the separation of the materials according to the differences in size;
at least one air separator (20) for the separation of the materials on the basis of differences in grain shape, grain size and/or specific weight;
at least one magnetic separator (30) for the separation of the materials on the basis of differences in their magnetic properties;
at least one eddy current separator (42) for the separation of the materials on the basis of differences in their electric properties; and
at least one installation (40, 64) for the separation of the materials on the basis of differences in their spectroscopic properties, characterized by the fact that
by using screens (12, 14, 16), air separator(s) (20), magnetic separator(s) (30), eddy current separator(s) (42) and the installations (40,64) a mixture results that contains non-recyclable residual waste and plastic articles and by the fact that further downstream a sorting installation (50) is fitted which collectively extracts the mixed plastic fraction from the mixture and supplies it to a module (60) where the mixed plastic fraction is sorted into polymer groupings whereby the module (60) is fitted with at least one separation installation (64) that uses near infrared spectroscopy which selectively sorts the mixed plastic fraction into essentially type-specific polymer groupings.

10. Device according to claim 9, characterized by the fact that the sorting installation (50) uses a NIR spectroscopic process for the separation.

11. Device according to claim 9 or 10, characterized by the fact that the separation installation (64) is series-connected to an air separator (62) or to a suction charged inclined conveyer belt leading the heavy fraction to the separation installation (64).

12. Device according to claim 9 to 11, characterized by the fact that for every polymer grouping the separation installation (64) is connected downstream to a buffer (66).
